(19) United States
(12) Patent Application Publication
(10) Pub. No.: US 2011/0029878 A1
(43) Pub. Date: Feb. 3, 2011

(54) MULTI-FUNCTIONAL PERIPHERAL AND SYSTEM

(75) Inventor: Ritsuko Matsumoto, Osaka (JP)

Correspondence Address: EDWARDS ANGELL PALMER & DODGE LLP, P.O. BOX 55874, BOSTON, MA, 02205, US

(73) Assignee: SHARP KABUSHIKI KAISHA, Osaka (JP)

(21) Appl. No.: 12/846,239

(22) Filed: Jul. 29, 2010

(30) Foreign Application Priority Data
Aug. 3, 2009 (JP) 2009-180677

(51) Int. Cl. G06F 3/01; G06F 21/00; G06F 15/16

(52) U.S. Cl. 715/733; 726/3

(57) ABSTRACT

A multi-functional peripheral receives at a time of logging in initial screen information managed by the authentication server relating it with login information used for the user authentication processing. A display controlling portion displays a screen corresponding to the initial screen information as an initial screen after login. The display controlling portion, in the case of detecting that the initial screen information is information indicating a screen relating to a function of an application and a function of the application is changed in the application server, displays an alternative screen giving a notification that the function of the application is changed, as the initial screen after login.

### CROSS-NOTING PARAGRAPH

This non-provisional application claims priority under 35 U.S.C. §119(a) on Patent Application No. 2009-180677 filed in JAPAN on Aug. 3, 2009, the entire contents of which are hereby incorporated herein by reference.

### FIELD OF THE INVENTION

The present invention relates to a multi-functional peripheral capable of performing user authentication processing in cooperation with an authentication server and capable of performing processing in cooperation with an application program (application) that is stored in an external application server, and a system provided with the multi-functional peripheral, the authentication server and the application server.

### BACKGROUND OF THE INVENTION

Conventionally, a system has been proposed in which functions of applications which operate on a personal computer (PC) and the function of a multi-functional peripheral are associated with each other, so that the multi-functional peripheral can operate as a part of the total application system. By using the system and loading external authentication/tabulation applications therein, it is also possible to perform uniform management of the accounting functions including authentication/tabulation of the multi-functional peripheral by the server.

Moreover, in a conventional multi-functional peripheral, a default screen (a copy screen etc.) specified by a setting in the multi-functional peripheral is displayed as an initial screen after logging in.

Japanese Laid-Open Patent Publication No. 2008-273126 discloses a multi-functional peripheral capable of displaying a preferred initial screen for each user when an authentication has been completed successfully with the use of an authentication function provided in the multi-functional peripheral itself. This multi-functional peripheral is configured such that as a preferred initial screen, a screen of the function that is selected first when a plurality of functions are sequentially selected during login or a screen of the function that is frequently selected first is displayed.

Moreover, Japanese Laid-Open Patent Publication No. 2007-55099 discloses a multi-functional peripheral that reads customization information including data of a customized screen of the user who has been registered in advance based on user identification information read by user authentication means and displays the customized screen on a display portion.

However, the multi-functional peripheral described in Japanese Laid-Open Patent Publication No. 2008-273126 and Japanese Laid-Open Patent Publication No. 2007-55099 does not correspond to the system as described above in which the multi-functional peripheral can operate as a part of the total application system, so that only a screen of the function of the multi-functional peripheral itself serves as the initial screen and the screen displayed when connected to an external application server can not be used as the initial screen.

That is, in the multi-functional peripheral described in Japanese Laid-Open Patent Publication No. 2008-273126, it is impossible to shift to a screen on which an application of an external application server (external application) can be operated immediately after login. Accordingly, it is necessary after login to select a menu relating to the external application out of menus of the functions unique to the multi-functional peripheral, such as copy, in order to use the external application.

Further, even when improvement is made such that a screen of an external application function is able to be set as the initial screen after login, this function is a function that is provided from the external application server, and therefore, it is assumed that an administrator replaces it with another external application depending on a timing to be used (including version upgrade) or the external application itself is deleted and can not be used. In such a case, a phenomenon which is not assumed by a user occurs such that a totally different external application is activated after login, the external application is not activated and an error occurs, or the like.

### SUMMARY OF THE INVENTION

An object of the present invention is to provide a multi-functional peripheral capable of performing user authentication processing in cooperation with an authentication server and processing in cooperation with an application that is stored in an external application server (processing for realizing the function of an external application), allowing a user to access a screen managed by the authentication server immediately after login without necessity of switching a screen of the function of the multi-functional peripheral itself and a screen of the function of the external application with each login and preventing a phenomenon which is caused by change and deletion of the external application and not assumed by a user even in the case of displaying a screen of the function of the external application, and a system provided with the multi-functional peripheral, the authentication server and the application server.

The first technical means of the present invention is a multi-functional peripheral connected to an authentication server and an application server, capable of performing user authentication processing via the authentication server and capable of performing processing in cooperation with an application program stored in the application server, comprising: a display portion; an information reception portion for receiving at a time of logging in from the authentication server initial screen information managed by the authentication server relating it with login information used for the user authentication processing; and a display controlling portion for displaying on the display portion a screen corresponding to the initial screen information received at the information reception portion as an initial screen after login, wherein the display controlling portion, in case of detecting that the initial screen information is information indicating a screen relating to a function of the application program and the function of the application program is changed in the application server, displays on the display portion an alternative screen giving a notification that the function of the application program is changed, as the initial screen after login.

The second technical means of the present invention is the multi-functional peripheral as defined in the first technical means, wherein the display controlling portion, when the initial screen information is information indicating a screen relating to the function of the application program, acquires data of a screen corresponding to the initial screen information from the application server to display on the display portion the screen as the initial screen after login.

The third technical means of the present invention is the multi-functional peripheral as defined in the first technical means, wherein the display controlling portion detects a change of the function of the application program by receiving a time and date of change recorded on the application server at a time of a change of the application program and comparing the time and date of change and a time and date of previous logout.

The forth technical means of the present invention is the multi-functional peripheral as defined in the first technical means, wherein the display controlling portion, in case of receiving by a user operation an activation instruction of the application program after changing while displaying the alternative screen, displays an initial screen of the application program after changing on the display portion.

The fifth technical means of the present invention is the multi-functional peripheral as defined in the forth technical means, wherein the display controlling portion acquires data of the initial screen of the application program after changing from the application server.

The sixth technical means of the present invention is the multi-functional peripheral as defined in the first technical means, wherein the display controlling portion, in case of receiving by the user operation a non-activation instruction of the application program after changing while displaying the alternative screen, displays a default screen of the multi-functional peripheral on the display portion.

The seventh technical means of the present invention is the multi-functional peripheral as defined in the first technical means, wherein the display controlling portion displays the alternative screen on the display potion as the initial screen after login only in case where the function of the application program that is changed is not compatible with the multi-functional peripheral, and displays on the display portion the screen corresponding to the initial screen information as an initial screen after login in case of being compatible.

The eight technical means of the present invention is the multi-functional peripheral as defined in the seventh technical means, wherein the display controlling portion presents a notification on the alternative screen also regarding a function whose use is restricted by being incompatible.

The ninth technical means of the present invention is a system provided with the multi-functional peripheral as defined in the first technical means, the authentication server and the application server.

The tenth technical means of the present invention is a system provided with the multi-functional peripheral as defined in the third technical means, the authentication server and the application server, wherein the application server, when the application program is changed, records the time and date of the change and transmits the time and date of the change either when it is recorded or when it is required by the multi-functional peripheral.

### BRIEF DESCRIPTION OF THE DRAWINGS

FIG. 1 is a block diagram illustrating an example of a schematic configuration of a system including a multi-functional peripheral according to an embodiment of the present invention;

FIG. 2 is a flowchart for describing an example of initial screen display processing in the system of FIG. 1;

FIG. 3 is a diagram illustrating an example of a login screen displayed in the multi-functional peripheral in the initial screen display processing of FIG. 2;

FIG. 4 is a diagram illustrating a sequence of login screen display processing performed after the multi-functional peripheral is turned on in the initial screen display processing of FIG. 2;

FIG. 5 is a diagram illustrating an example of a user management table managed by a user information management DE of an authentication server in the system of FIG. 1;

FIG. 6 is a diagram illustrating an example of setting screen information managed by the user information management DB of the authentication server in the system of FIG. 1;

FIG. 7 is a diagram illustrating an example of a copy screen displayed in the multi-functional peripheral as an initial screen after login by the initial screen display processing of FIG. 2;

FIG. 8 is a diagram illustrating an example of a scan screen displayed in the multi-functional peripheral as an initial screen after login by the initial screen display processing of FIG. 2;

FIG. 9 is a diagram illustrating an example of a fax screen displayed in the multi-functional peripheral as an initial screen after login by the initial screen display processing of FIG. 2;

FIG. 10 is a diagram illustrating an example of application information managed by an application information management DB of an application server in the system of FIG. 1;

FIG. 11 is a diagram illustrating an example of a document management application screen displayed in the multi-functional peripheral as an initial screen after login by the initial screen display processing of FIG. 2;

FIG. 12 is a diagram illustrating an example of an alternative screen displayed in the multi-functional peripheral as an initial screen after login by the initial screen display processing of FIG. 2;

FIG. 13 is a diagram illustrating another example of an alternative screen displayed in the multi-functional peripheral as an initial screen after login by the initial screen display processing of FIG. 2; and

FIG. 14 is a flowchart for describing an example of processing for displaying an alternative screen in the multi-functional peripheral as an initial screen after login by the initial screen display processing of FIG. 2 and subsequent display processing.

### PREFERRED EMBODIMENTS OF THE INVENTION

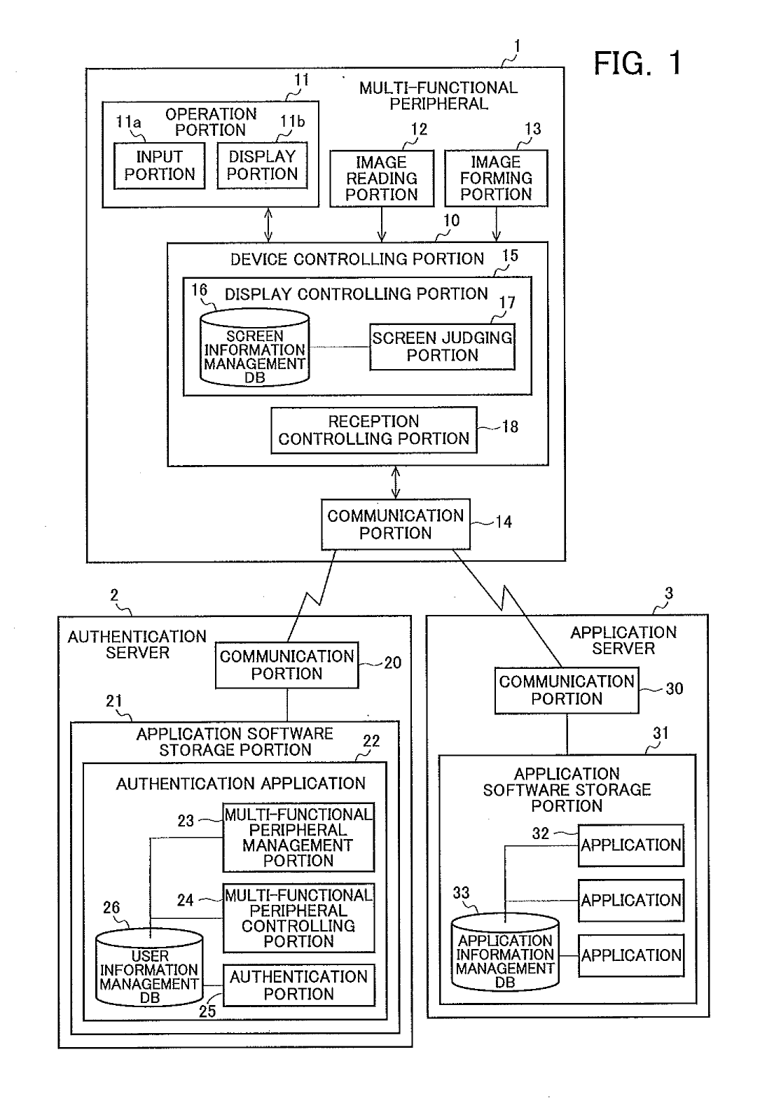

FIG. 1 is a block diagram illustrating a schematic configuration example of a system including a multi-functional peripheral according to an embodiment of the present invention. The system shown in FIG. 1 is provided with a multi-functional peripheral 1, an authentication server 2 and an application server (external application server) 3.

The application server 3 may be configured as an apparatus which is physically the same as the authentication server 2. Moreover, both the application server 3 and the authentication server 2 may be configured to incorporate a server program on a PC. Note that, what is simply called an “application” herein indicates an application program (application software).

The multi-functional peripheral 1 is a digital multi-functional peripheral or an analogue multi-functional peripheral, and is provided with a device controlling portion 10, an operation portion 11, an image reading portion 12, an image forming portion 13 and a communication portion 14. The operation portion 11 has an input portion 11a and a display portion 11b such as an LCD (Liquid Crystal Display). The input portion 11a has various input key groups and a touch panel for accepting user input provided in the display portion 11b.

The device controlling portion 10 controls each portion included in the multi-functional peripheral 1. In addition, the device controlling portion 10 is provided with a display controlling portion 15 for controlling a display screen on the display portion 11b, and the display controlling portion 15 has a screen information management database (DB) 16 and a screen judging portion 17. The screen information management DB 16 is a database that manages data of each screen included in the multi-functional peripheral 1. The screen judging portion 17 judges a screen to be displayed on the display portion 11b based on such as a user operation from the input portion 11a. Based on the judgment result, the display controlling portion 15 searches data of a screen to be displayed from the screen information management DB 16 and provides the data to the display portion 11b and causes the display portion 11b to display the data. In addition, the device controlling portion 10 is provided with a reception controlling portion 18 described below.

The image reading portion 12 reads an original placed on a document platen or an automatic document feeder and inputs image data. The image forming portion 13 performs printing processing for image data input from the image reading portion 12 or image data input from an external PC via the communication portion 14. This system allows printing to be executed and therefore can be said as a “printing system”. The communication portion 14 communicates with an information processing apparatus via a network such as a wired LAN (Local Area Network) or a wireless LAN. As the information processing apparatus to be communicated, an authentication server 2 and an application server 3 are incorporated in the system.

The authentication server 2 is a server computer provided with a communication portion 20 and an application software storage portion 21. The communication portion 20 communicates with the multi-functional peripheral 1 via the network such as a wired LAN or a wireless LAN. The application software storage portion 21 stores an authentication application 22 for controlling authentication processing in the multi-functional peripheral 1.

The authentication application 22 is provided with a multi-functional peripheral management portion 23, a multi-functional peripheral controlling portion 24 and an authentication portion 25, and is provided with a user information management DB 26 as data. The multi-functional peripheral management portion 23 associates user information with the multi-functional peripheral 1. The multi-functional peripheral controlling portion 24 manages valid/invalid of each elemental function of the multi-functional peripheral 1. Each of the elemental functions will be described below. The authentication portion 25 carries out user authentication. The user information management DE 26 is a database in which user information is managed.

The device controlling portion 10 of the multi-functional peripheral 1 transmits, via the communication portion 14 and the communication portion 20 between the authentication application 22 stored in the authentication server 2, information of a user operation input by the input portion 11a (hereinafter referred to also as operation panel information) to the authentication server 2 side as well as exchanges information for controlling a device of a communication party and device control information serving as information responding thereto, while calling the function of the authentication application 22 to acquire the result of authentication processing thereof. This allows the multi-functional peripheral 1 to perform processing in cooperation with the authentication application 22 (processing for realizing the function of the authentication application, that is, authentication processing).

The application server 3 is a server computer provided with a communication portion 30 and an application software storage portion 31. The communication portion 30 communicates with the multi-functional peripheral 1 via the network such as a wired LAN or a wireless LAN. The application software storage portion 31 stores an application 32 for controlling the multi-functional peripheral 1 and stores an application information management DB 33 therein. The application information management DB 33 is a database that manages information relating to the application 32 stored. The information includes at least update information (a time and date of update etc.) relating to update by which a function of the application 32 is changed.

The device controlling portion 10 of the multi-functional peripheral 1 transmits, via the communication portion 14 and the communication portion 30 between the application 32 stored in the application server 3, the operation panel information to the application server 3 side as well as exchanges the device control information, while calling the function of the application 32 to acquire the result of processing thereof. Note that, the application 32 is an application that is saved outside looking from the side of the multi-functional peripheral 1 and is also called an external application, and a function of the application 32 is also called an external application function.

This allows the multi-functional peripheral 1 to perform processing in cooperation with the application 32 (processing for realizing the external application function). One external application function corresponds to one application stored in the application server 3 and is able to be provided in the multi-functional peripheral 1 for each application stored.

The operation panel information and the device control information described above are transmitted including device information of a device on the transmitting side so that a transmission source can be recognized on the receiving side. The device information is information unique to the device and indicates identification information for enabling identification from other devices. Illustrating the multi-functional peripheral 1, the device information is identification information for enabling identification of the multi-functional peripheral 1 from other devices (other multi-functional peripherals and the authentication server 2 etc.) and examples thereof include a device number (serial number) unique to the multi-functional peripheral 1 and a MAC (Media Access Control) address.

Here, it is preferable that the exchanging of information between the multi-functional peripheral 1 and the application 32 is performed based on a standard network technology in terms of that a lot of general tools and skills can be used for development of a part of cooperation between the application 32 and the device controlling portion 10 (firmware in the device controlling portion 10) of the multi-functional peripheral 1 and mounting thereof is easy. Note that, same thing can be said of the exchanging of information between the authentication application 22 and the multi-functional peripheral 1 described above.

Next, description will be given for a case where processing for displaying an initial screen (initial screen after logging in) is applied to the system having the configuration described above.

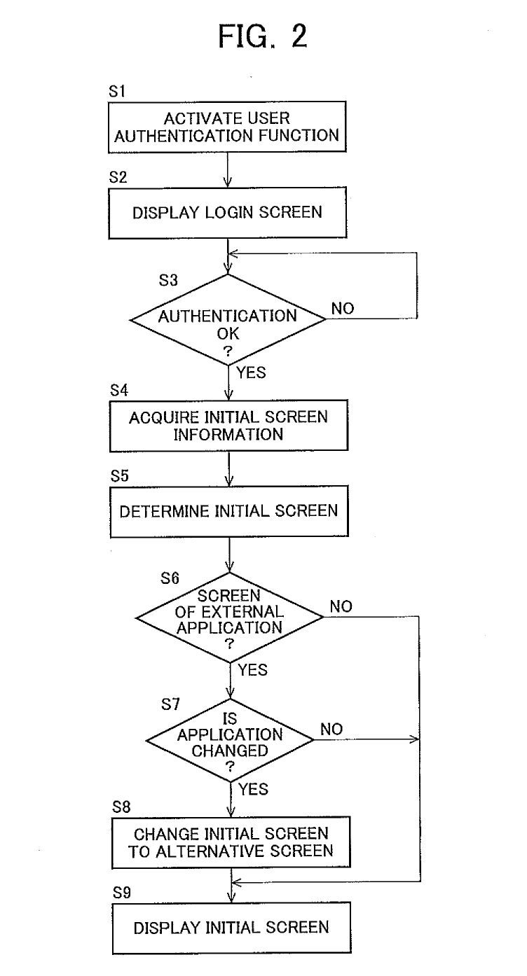

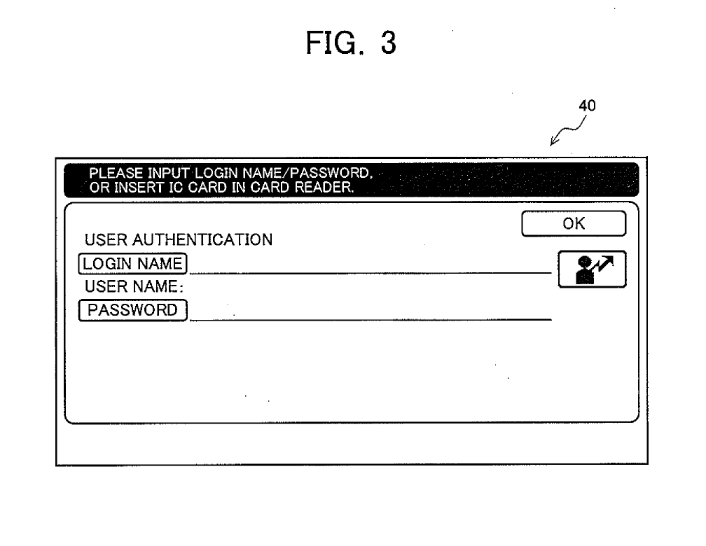

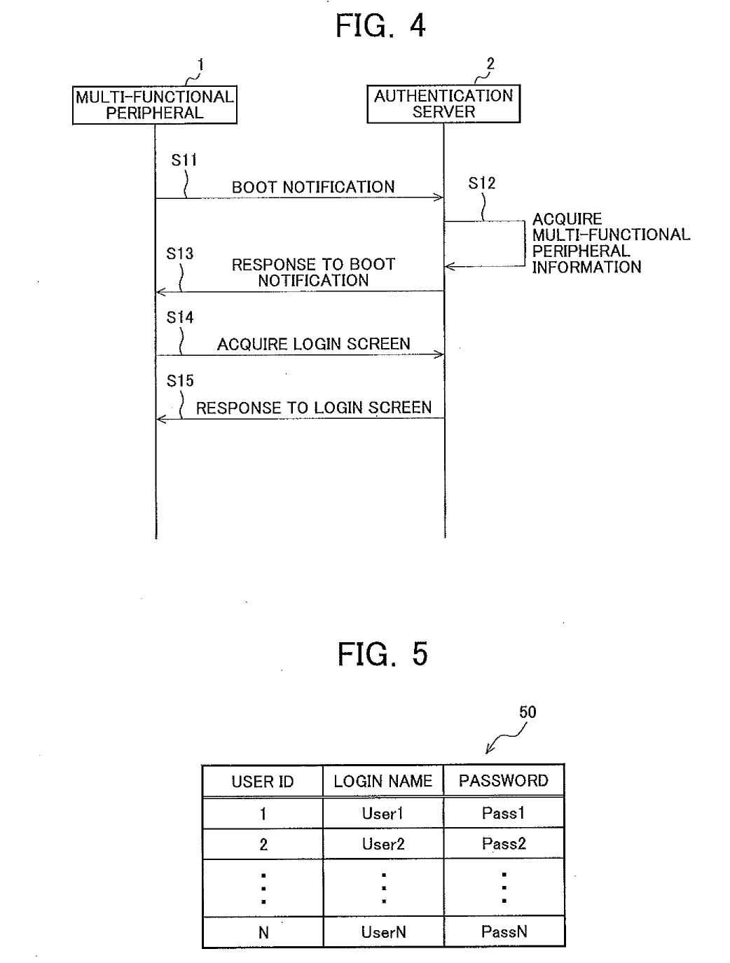

FIG. 2 is a flowchart for describing an example of initial screen display processing in the system of FIG. 1. Further, FIG. 3 is a diagram illustrating an example of a login screen displayed in the multi-functional peripheral in the initial screen display processing of FIG. 2 and FIG. 4 is a diagram illustrating a sequence of login screen display processing performed after the multi-functional peripheral is turned on in the initial screen display processing of FIG. 2.

User authentication processing performed by the multi-functional peripheral 1 and the authentication server 2 in cooperation starts from activating the authentication function first (step S1). At step S1, when an administrator of the multi-functional peripheral performs an operation of activating the user authentication function from the operation portion 11, information thereof is transmitted to the device controlling portion 10 and the user authentication function is set to be valid.

When the user authentication function is activated, the device controlling portion 10 of the multi-functional peripheral 1 causes the display portion 11b to display an authentication screen (login screen) acquired from the authentication server 2 (step S2). Thereby, for example, a login screen 40 of FIG. 3 is displayed. The login screen 40 allows inputting of a login name and a password. In addition, when the user authentication is performed by an IC (Integrated Circuit) card etc., the login screen 40 also displays a sentence for urging to insert the IC card into a card reader.

The processing for displaying the login screen 40 at step S2 will be described in detail with reference to FIG. 4. Although the login screen 40 is acquired from the authentication server 2 as described above, it is necessary in the acquirement that the authentication server 2 regards the multi-functional peripheral 1 as an authentication target.

Therefore, when the user authentication function is activated at step S1, the device controlling portion 10 of the multi-functional peripheral 1 transmits a boot notification including the device information of the multi-functional peripheral 1 and information indicating that the user authentication function has been activated to the authentication server 2 (step S11). Note that, including the transmission processing in this case, the transmission processing from the multi-functional peripheral 1 to the authentication server 2 is performed such that the device controlling portion 10 gives an instruction to the communication portion 14 and the communication portion 14 transmits to the authentication server 2, which is received by the communication portion 20 of the authentication server 2. Moreover, the information transmitted at step S11 and steps S13 to S15 described below corresponds to the device control information described above.

The same processing as the processing at step S11 is also performed when the user authentication function is changed from valid to invalid and a boot notification including the device information of the multi-functional peripheral 1 and information indicating that the user authentication function has been invalidated is transmitted to the authentication server 2. In addition, when the multi-functional peripheral 1 is turned on, the processing at step S11 is also performed under the condition that the user authentication function has been already activated, and the boot notification including the device information of the multi-functional peripheral 1 is transmitted to the authentication server 2.

When the authentication application 22 which operates on the authentication server 2 receives the boot notification at step S11 from the communication portion 20, the multi-functional peripheral management portion 23 acquires multi-functional peripheral information from an internal memory (internal memory of the authentication server 2) using the device information as a key (step S12). Here, the multi-functional peripheral information includes device information of the multi-functional peripheral, information indicating whether the multi-functional peripheral indicated by the device information is powered on or off and information indicating whether or not the multi-functional peripheral indicated by the device information is targeted for the authentication (targeted for performing the user authentication processing).

Further, when detecting, from the acquired multi-functional peripheral information, that the multi-functional peripheral 1 is powered on from off among multi-functional peripherals managed by the multi-functional peripheral information, the multi-functional peripheral management portion 23 rewrites the multi-functional peripheral information so as to regard the multi-functional peripheral 1 as the authentication target under the condition that the user authentication function has been already activated. On the other hand, when detecting, from the acquired multi-functional peripheral information, that the user authentication function of the multi-functional peripheral 1 is changed from invalid to valid, the multi-functional peripheral management portion 23 (I) rewrites the multi-functional peripheral information regarding the multi-functional peripheral 1 as the authentication target (rewrites from invalid to valid) or (II) creates multi-functional peripheral information from the device information by newly adding as the authentication target. Such processing allows the multi-functional peripheral management portion 23 to add the multi-functional peripheral 1 as the authentication target.

Note that, when detecting that another multi-functional peripheral is powered on, the multi-functional peripheral management portion 23 may rewrite the multi-functional peripheral information so as to exclude the multi-functional peripheral which has been the authentication target as being powered on (the multi-functional peripheral 1 in this example) from the authentication target, but it is preferable that a plurality of multi-functional peripherals remain the authentication target simultaneously so that a plurality of multi-functional peripherals correspond. Further, when the boot notification including information indicating that the user authentication function has been invalidated is received, the multi-functional peripheral information may be rewritten (rewritten from valid to invalid) so as to exclude the multi-functional peripheral 1 from the authentication target or the multi-functional peripheral information itself of the multi-functional peripheral 1 may be deleted.

Subsequent to step S12, the authentication application returns a response (information indicating that, for example, the user authentication function is turned on and the boot can be confirmed) to the boot notification via the communication portion 20 (step S13). Including the transmission processing in this case, the transmission processing from the authentication server 2 to the multi-functional peripheral 1 is performed such that the authentication application 23 gives an instruction to the communication portion 20 and the communication portion 20 transmits to the multi-functional peripheral 1, which is received by the communication portion 14 of the multi-functional peripheral 1.

The device controlling portion 10 of the multi-functional peripheral 1 that has received the response at step S13 requests acquirement of a login screen via the communication portion 14 (step S14). Upon the request, the authentication application 22 reads out the login screen 40 from the internal memory of the authentication server 2 via the communication portion 20 to return to the multi-functional peripheral 1 (step S15). Then, the device controlling portion 10 of the multi-functional peripheral 1 causes the display portion 11b to display the received login screen 40 as an operation screen. Thereby, the processing at step S2 of FIG. 2 is completed.

After the processing at step S2 of FIG. 2, a user inputs login information consisting of a user name and a password (or information in an IC card) by the input portion 11a (or an IC card reader), and the device controlling portion 10 that has received it requests user authentication processing to the authentication server 2 and the authentication application 22 of the authentication server 2 that has received the request determines whether the authentication has been completed successfully (step S3).

The user authentication processing at step S3 will be described in detail with reference to FIG. 5. FIG. 5 is a diagram illustrating an example of a user management table managed by the user information management DB of the authentication server in the system of FIG. 1. A user management table 50 of FIG. 5 is included in the user information management DB 26, in which a login name and a password are stored in association with each other for each user ID as each user authentication information.

The login information input by the user is transmitted from the multi-functional peripheral 1 to the authentication server 2. The login information is transmitted as the operation panel information described above. Then, the authentication portion 25 matches the received login information and the user management table 50 to carry out the authentication based on whether or not there is user authentication information in conformity with the received login information in the user management table 50.

When the authentication has failed (in the case of NO at step S3), a response is given to the multi-functional peripheral 1 side as an authentication error, and the device controlling portion 10 of the multi-functional peripheral 1 causes the display portion 11b to display the login screen transmitted simultaneously depending on the response (or the login screen held in the multi-functional peripheral 1 until the authentication has been completed successfully) to urge re-entry to the user. Only when the authentication has been completed successfully, the flow goes to step S4 described below. In this manner, the multi-functional peripheral 1 is able to carry out the user authentication in cooperation with the authentication server 2.

When the authentication has been completed successfully (in the case of YES at step S3), the multi-functional peripheral controlling portion 24 closes the login screen as well as transmits a control command for activating or invalidating each function of the multifunctional peripheral 1 to the multi-functional peripheral 1, which is not illustrated. The multi-functional peripheral 1 that has received the control command closes the login screen as well as activates or invalidates the function of the multi-functional peripheral 1.

The validating (activating)/invalidating processing may be executed based on a function valid/invalid management table described later that is included in the user information management DB 26. In the function valid/invalid management table, information indicating valid/invalid of each function (elemental function) of the multi-functional peripheral is stored in association with each other for each user ID. Note that, the information indicating valid/invalid (referred to as valid/invalid information) is the information indicating user restriction to the function and can be also expressed as authority information.

The multi-functional peripheral controlling portion 24 manages the valid/invalid information for each elemental function described in the function valid/invalid management table by rewriting depending on a changing request from the multi-functional peripheral 1 side. Note that, only when the login information of the administrator user is transmitted from the multi-functional peripheral 1, the changing request may be enabled, that is, update may be enabled. Further, the multi-functional peripheral controlling portion 24 controls to restrict each elemental function on the multi-functional peripheral 1 side based on the managed valid/invalid information.

In the function valid/invalid management table, elemental functions may be managed by classifying into large categories (categories of operation modes here) such as a copy function, a scan function, a fax function, a print function and a document management application function, but, for example, scan may be classified into specific categories such as a function of scan to e-mail transmission and a function of scan to FTP (File Transfer Protocol) transmission. Further, the valid/invalid information may be managed for each specific setting such as managing of the valid/invalid information by classifying into a category such as color information (monochrome/full-color).

The document management application function indicates the function in cooperation with the document management application stored in the application server 3 as one of the applications 32. In this manner, the external application function is also targeted for management here. As in this example, not only for each function of the multi-functional peripheral itself, the valid/invalid information for the external application function is also managed. The valid/invalid information may be managed for each application 32 stored in the application server 3 so as to be executable when being in cooperation with the multi-functional peripheral 1, that is, for each external application function. Further, the valid/invalid information may be managed, for example, for each application 32 or for each setting in the application 32 by classifying into more specific categories. In addition, regarding the functions that can be also used in combination with the external application function, such as a print function, the valid/invalid information may be managed for each combination thereof. For example, management may be performed with the valid/invalid information of the function for printing using the function of the multi-functional peripheral itself and the valid/invalid information of the function for printing using the external application function. Of course, the valid/invalid information may be managed only for each function of the multi-functional peripheral itself.

When the authentication has been completed successfully (in the case of YES at step S3), the multi-functional peripheral controlling portion 24 firstly refers to the function valid/invalid management table described above based on the login information and determines whether each function of the multi-functional peripheral 1 is valid or invalid for the user indicated by the login information by reading out the valid/invalid information. More specifically, using the user ID logged in as a key, the valid/invalid information corresponding to the matching user ID is extracted from the function valid/invalid management table and valid/invalid is determined for each function determined for the user based on the extracted valid/invalid information.

Then, the multi-functional peripheral controlling portion 24 generates a control command to, for the user, activate the function of the multi-functional peripheral 1 that is valid and invalidate the function of the multi-functional peripheral 1 that is invalid to transmit to the multi-functional peripheral 1. The device controlling portion 10 of the multi-functional peripheral 1 that has received the control command activates or invalidates each function of the multi-functional peripheral 1.

In this manner, the authentication server 2 is able to control for each user permission for using the functions of the multi-functional peripheral itself (for example, a copy function, a scan function, a fax function and a print function etc.) and permission for using the external application function with respect to the multi-functional peripheral 1.

In addition, regarding the processing for closing the login screen, a command for closing may be included in the control command above so that the multi-functional peripheral 1 that has received the control command closes the login screen accordingly.

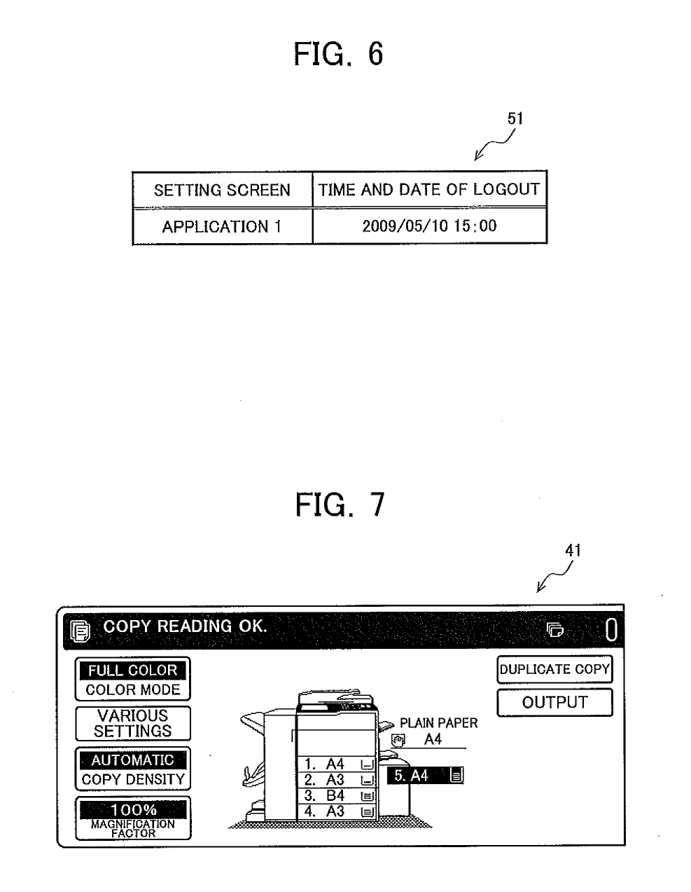

In the present invention, control is performed to display the following initial screen (initial screen after login) on the display portion 11b after the login screen closed in this manner. Note that, the processing for closing the login screen may be performed at the same time when the following display control is performed. An example of the control that is processing after step S4 of FIG. 2 will be described with reference to FIGS. 6 to 14.

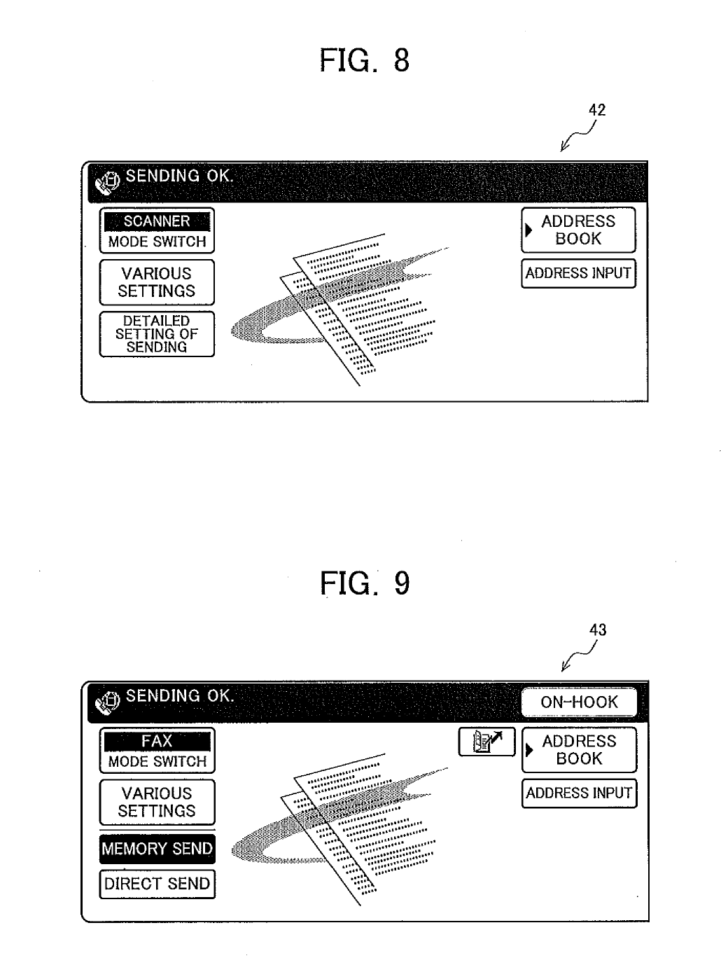

FIG. 6 is a diagram illustrating an example of setting screen information managed by the user information management DB of the authentication server in the system of FIG. 1. FIG. 7 is a diagram illustrating an example of a copy screen displayed in the multi-functional peripheral as an initial screen after login by the initial screen display processing of FIG. 2, FIG. 8 is a diagram illustrating an example of a scan screen displayed in the multi-functional peripheral as an initial screen after login by the initial screen display processing of FIG. 2 and FIG. 9 is a diagram illustrating an example of a fax screen displayed in the multi-functional peripheral as an initial screen after login by the initial screen display processing of FIG. 2.

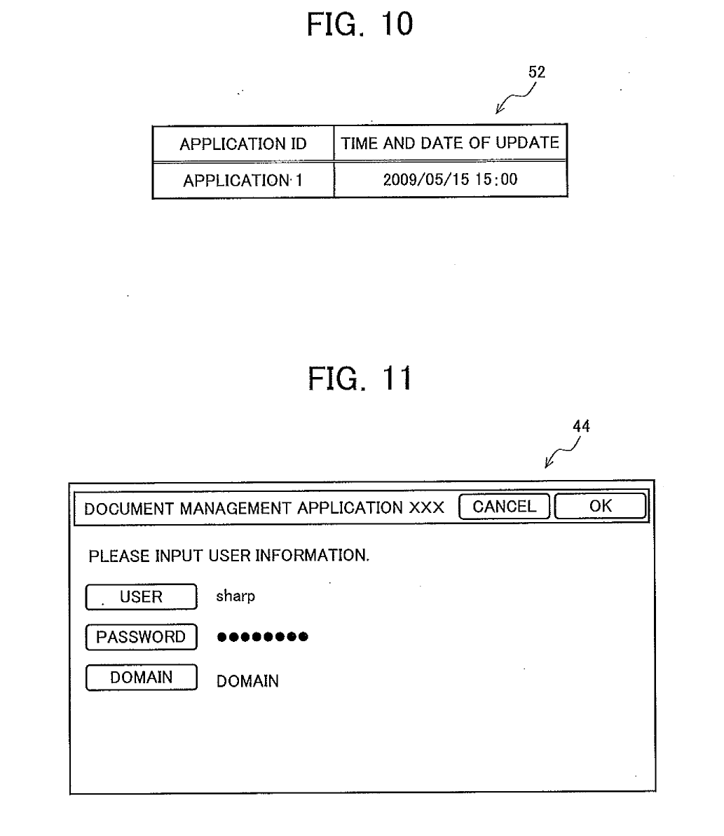

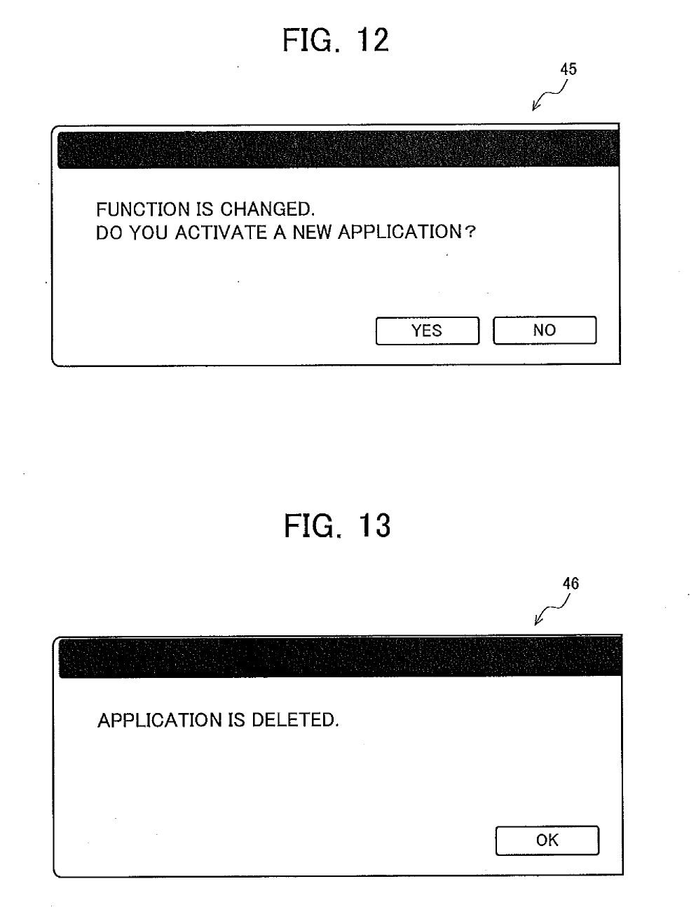

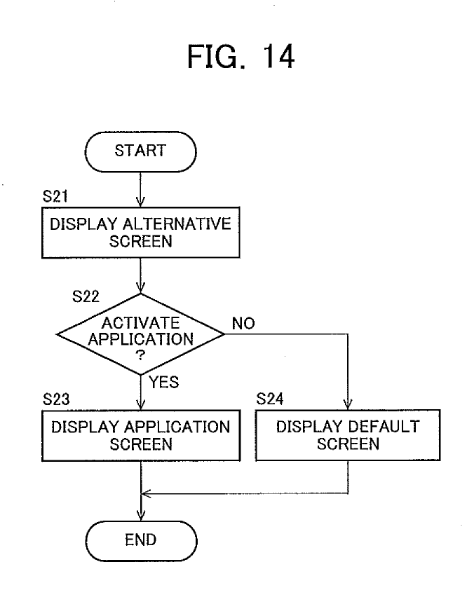

Further, FIG. 10 is a diagram illustrating an example of application information managed by an application information management DB of an application server in the system of FIG. 1 and FIG. 11 is a diagram illustrating an example of a document management application screen displayed in the multi-functional peripheral as an initial screen after login by the initial screen display processing of FIG. 2. Furthermore, FIG. 12 is a diagram illustrating an example of an alternative screen displayed in the multi-functional peripheral as an initial screen after login by the initial screen display processing of FIG. 2 and FIG. 13 is a diagram illustrating another example of the alternative screen. FIG. 14 is a flowchart for describing an example of processing for displaying an alternative screen in the multi-functional peripheral as an initial screen after login by the initial screen display processing of FIG. 2 and subsequent display processing.

In order to display an initial screen after login, the multi-functional peripheral controlling portion 24 of the authentication server 2 firstly acquires initial screen information described below from the user information management DB 26 (step S4).

The initial screen information is the information for indicating the initial screen to be displayed at the time of logging in next time by the multi-functional peripheral 1. The initial screen information is managed by the authentication server 2 in association with login information (i.e. user information) and may be stored as an initial screen management table in the user information management DB 26, for example. In the initial screen management table, initial screen information is stored in association with each other for each user ID.

As the initial screen information, information indicating a last screen at the time of previous logout (identification information for identifying a screen) may be employed. Specifically, the multi-functional peripheral 1 transmits the identification information to the side of the authentication server 2 at the time of logging out first. Then, the multi-functional peripheral controlling portion 24 of the authentication server 2 relates the identification information with login information (user ID) and stores them in the initial screen management table. By receiving identification information of a screen related with a logged out user ID for every logging out, the multi-functional peripheral controlling portion 24 is able to keep the initial screen management table up to date. This makes it possible to read out the identification information using login information as a key when login is performed (that is, at the time of logging in next time) and transmit the identification information to the multi-functional peripheral 1.

In addition, as the initial screen information, the following last usage function information may be employed. The last usage function information is the information indicating the elemental function that is lastly used (that is used most recently) by the user in the previous login. First, the multi-functional peripheral 1 transmits to the authentication server 2 the usage function information indicating the elemental function (usage function) selected by the user operation during the time after login information is transmitted to the authentication server 2 and the user authentication processing is performed by the authentication server 2 until immediately after logging out. Herein, the usage function information may be transmitted to the authentication server 2 every time when selection is made by the user operation. Then, the multi-functional peripheral controlling portion 24 of the authentication server 2 updates the last usage function information corresponding to the login information based on the received usage function information and thereby updates the initial screen management table. This makes it possible to read out the usage function information using the login information as a key when login is performed (that is, at the time of logging in next time) and to transmit the usage function information to the multi-functional peripheral 1.

Moreover, as another method of the processing for updating the initial screen management table, the multi-functional peripheral 1 may issue the notification of the last usage function information at the time of logging out. For example, when a screen before logging out is a copy screen, a scan screen, a fax screen and a document management application screen, notification of a copy function, a scan function, a fax transmission function and a document management application function may be issued as the last usage function information, respectively. Whereby, it is only needed to update the initial screen management table at the time of logging out.

In addition, the processing for updating the initial screen management table may be performed by receiving information of a job that was actually executed from the multi-functional peripheral 1. Specifically, first, when the user actually execute a job by using a function of the multi-functional peripheral 1, the device controlling portion detects the execution of the job, and notifies the authentication server 2 of the detailed information of the executed job as job result notification. The detailed information of a job mainly indicates the following information. In other words, execution user information, a model name of a multi-functional peripheral (MFP), a serial number of an MFP, an installation location of an MFP, a MAC address of an MFP, a network address of an MFP, identification ID of an execution job, types of jobs (copy, printing, ScanToEmail, ScanToFTP, etc.), start time/finish time, a document size, a double-sided setting, a color setting, staple information, punch information, a file format, a compression format, resolution, the total number of sheets (the number of transmitted sheets and the number of printed sheets), and the like, correspond to the detailed information of a job.

As illustrated, since the job result notification includes information of executed functions, the multi-functional peripheral controlling portion 24 of the authentication server 2 updates the initial screen management table of the user information management DB 26 based on the information given with the execution of the job. For such identification/update, a corresponding table in which executed function information included in job result notification corresponds to last usage functions may be stored in the user information management DB 26. For example, when a type of executed jobs is a copy, the last usage function can be dealt with as a copy function. Additionally, when a type of executed jobs is the ScanToEmail transmission or the ScanToFTP transmission, the transmission is a function executable from a scan screen, and therefore, setting the last usage function to scan is performed. Same thing can be said for a fax function and a document management application XXX function.

In this manner, the authentication server 2 manages initial screen information by relating it with login information used for authentication processing and transmits the initial screen information to the multi-functional peripheral 1. In addition, the multi-functional peripheral 1 has an information reception portion for receiving from the authentication server 2 initial screen information managed by the authentication server 2 by relating it with login information used for user authentication processing at the time of logging in. The information reception portion can be illustrated by mean of the communication portion 14 and the reception controlling portion 18 in the device controlling portion 10. Note that, the initial screen information may be transmitted with a display instruction (instruction to activate display of a screen indicated by the initial screen information) or may be transmitted without a display instruction. In the former case, the following processing may be executed in accordance with the display instruction, and even in the latter case, the following processing may be triggered by reception of the initial screen information.

The screen judging portion 17 of the device controlling portion 10, after it acquired the initial screen information corresponding to the login information at step S4 of FIG. 2 in this manner, determines a screen indicated by the initial screen information as the initial screen after login (step S5). The determination in this case serves as temporal determination as shown from the flow described below.

Description will be given with an example where setting screen information 51 shown in FIG. 6 is stored in the user information management DB 26 of the authentication server 2 as initial screen information. In the setting screen information 51, an ID “application 1” of the application 32 which is a function used by the user last time is recorded as information of a setting screen (initial screen). Note that, the setting screen information 51 illustrated in FIG. 6 stores the time and date of logout related to each elemental function (at least an external application function), the usage of which will be described later. In the case where information upon which the setting screen information 51 is based is not received from the multi-functional peripheral 1 at the time of logging out, the time and date of reception can be used replaced with the time and date of logout. Alternatively, when logout is detected, the time and date of logout may be recorded in the setting screen information separately.

When “application 1” is included as the initial screen information like this example, the screen judging portion 17 reads out “application 1” which is the content thereof from the setting screen information 51 and temporarily determines the screen of “application 1” as the initial screen after login at step S5.

Subsequently, the screen judging portion 17 judges whether or not the initial screen determined at step S5 is a screen of a function of the external application 32 based on the content of the initial screen information, that is, whether or not the received initial screen information is information indicating a screen of a function of the external application 32 (step S6).

The judgment may be performed by checking the setting screen information 51 received from the authentication server 2 with the screen information management DB 16. The setting screen information 51 may be judged as screen information included in the multi-functional peripheral 1 itself when included in the screen information management DB 16, and judged as screen information provided from outside when not included in the screen information management DB 16.

The case of NO at step S6 shows that the initial screen of a function of the multi-functional peripheral itself is determined at step S5. Accordingly, the display controlling portion 15 reads out the initial screen determined at step S5 as it is from the screen information management DE 16 to display on the display portion 11b (step S9). Thereby, for example, when logout has been performed on a copy screen in the previous login, an initial screen of a copy function (copy screen) 41 as illustrated in FIG. 7 is displayed on the display portion 11b. Similarly, when logout has been performed on a scan screen and a fax screen in the previous login, an initial screen of a scan function (scan screen) 42 illustrated in FIG. 8 and an initial screen of a fax function (fax screen) 43 illustrated in FIG. 9 are displayed on the display portion 11b, respectively.

the case of YES at step S6, that is, when an initial screen of an external application function is determined at step S5, the screen judging portion 17 further judges whether or not the application 32 is changed (step S7).

For the judgment at step S7, the multi-functional peripheral 1 transmits the setting screen information 51 to the application server 3 first and requests application information 52 of FIG. 10 based on the setting screen information 51.

The application information 52 illustrated in FIG. 10 is included in the application information management DB 33 of the application server 3, in which the time and date of update at the application server 3 is stored for each application 32. Therefore, when the application 32 is changed, the application server 3 records the time and date of the change by relating it with an ID of the application 32. Information recorded in this manner is the application information 52. When an administrator changes the application 32, the application information 52 has the time and date of update of the application 32 updated to be rewritten to the time and date on which changing is performed.

Then, the application server 3 returns the time and date of the change by the request from the multi-functional peripheral 1 and the like as described above. When acquiring from the side of the multi-functional peripheral 1, the request may be made by specifying the application 32, without limitation to the example where the request is made by transmitting the setting screen information 51.

The application server 3 checks the setting screen information 51 provided from the multi-functional peripheral 1 with the application information management DB 33 using an application ID included in the setting screen information 51 as a key. When there is an application matching the application ID provided from the multi-functional peripheral 1 in the application information management DB 33, the application server 3 transmits the application information 52 matching the application ID to the multi-functional peripheral 1. When there is no application matching the application ID provided from the multi-functional peripheral 1 in application information stored in the application information management DB 33, the application server 3 transmits empty data to the multi-functional peripheral 1. Thereby, the multi-functional peripheral 1 is able to receive information indicating the time and date on which the specified application 32 is changed, and even when the application 32 does not exist, the multi-functional peripheral 1 is able to know the fact the application 32 does not exist.

Note that, it may be configured such that the time and date of the change is spontaneously transmitted from the application server 3 to the multi-functional peripheral 1 such as when the time and date on which the application 32 is changed is recorded, and in such a case, together with information of the time and date of the change, information showing whether it is the time and date of the change with respect to the change of the application 32 is also transmitted.

The multi-functional peripheral 1 acquires the application information 52 from the application server 3 in this manner and compares the time and date of previous logout included in the setting screen information 51 provided from the authentication server 2 to the time and date of application update included in the application information 52 provided from the application server 3 at the screen judging portion 17.

In this manner, the screen judging portion 17 of the display controlling portion 15 detects the change of the function of the application 32 by receiving from the application server 3 the time and date of the change recorded at the time of changing the application 32 on the side of the application server 3 and comparing the time and date of the change to the time and date of previous logout.

In the case of NO as a result of executing the comparison at step S7 in this manner, that is, when the time and date of application update is earlier than the time and date of previous logout (the application is not changed), the display controlling portion 15 displays the initial screen determined at step S5 as it is on the display portion 11b (step S9). However, at processing of step S9 after step S7, the display controlling portion 15 of the multi-functional peripheral 1 instructs (requests) the application server 3 to return screen configuration data that defines the determined initial screen (screen corresponding to initial screen information), that is, screen configuration data of the application matching the application ID of the setting screen information 51. An example of the screen configuration data includes HTML (Hypertext Markup Language) data. Upon the instruction, the application server 3 then transmits the data to the multi-functional peripheral 1 and the display controlling portion 15 displays the received data on the display portion 11b as the initial screen after login.

Thereby, when logout has been performed on a screen of a document management application function in the previous login, for example, an initial screen of the document management application function (document management application screen) 44 as illustrated in FIG. 11 is displayed on the display portion 11b. The document management application screen 44 of FIG. 11 is an example of a display screen of an external application function. Note that, the document management application screen 44 is the screen of an application “document management application XXX” out of applications 32 stored in the application server 3, and is illustrated by means of a login screen for accessing the document management application XXX.

As described in the case of NO at steps S6 and S7, the display controlling portion 15 usually displays a screen corresponding to initial screen information received at the communication portion 14 and the reception controlling portion 18 on the display portion 11b as the initial screen after login.

Due to such processing, the user does not need to switch the function of the multi-functional peripheral itself and the external application function and, after login, is able to access a setting screen in the previous login easily. In this manner, according to the present invention, in the multi-functional peripheral 1 capable of performing user authentication processing in cooperation with the authentication server 2 and processing in cooperation with the application 32 stored in the external application server 3, since an initial screen at the time of logging in next time is able to be displayed based on initial screen information managed by the authentication server 2, for example, such as information of a setting screen at the time of logging out, the user does not need to switch the screen of the function of the multi-functional peripheral itself and the screen of the external application function every time logging in and, immediately after login, is able to access a screen of the previously used function easily. For example, since it is possible to shift to a screen allowing an operation of the external application 32 immediately after logging in the multi-functional peripheral 1, the operability is able to be enhanced.

On the other hand, in the case of YES at step S7, when the time and date of application update is later than the time and date of previous logout (the application is changed after the time and data on which the user used last time), the following processing is performed. That is, the display controlling portion 15 changes the initial screen after login determined at step S5 to an alternative screen giving a notification that the function of the application 32 is changed (step S8) and displays the alternative screen on the display portion 11b (step S9). In the examples of the setting screen information 51 of FIG. 6 and the application information 52 of FIG. 10, the time and date of application update is later and such a display instruction is given.

The alternative screen displayed on the display portion 11b by the instruction may describe that a function is changed and make an inquiry to the user about whether or not to activate a new application (updated application), for example, like an alternative screen 45 shown in FIG. 12. On the alternative screen 45, an “YES” button for activating and a “NO” button for not activating are displayed so as to be selectable by the user.

In this manner, the device controlling portion 10 of the multi-functional peripheral 1 has means for judging a function of an initial screen from initial screen information given from the authentication server 2 and means for detecting whether or not the function of the initial screen is changed. Moreover, the display controlling portion 15, in the case of detecting that i) initial screen information is information indicating a screen relating to a function of the application 32 and ii) the function of the application 32 is changed in the application server 3, displays an alternative screen giving a notice that the function of the application 32 is changed. Data of the alternative screen may be stored in the screen information management DB 16 and displayed by reading out the data. Alternatively, it may be configured such that the application server 3 is instructed (requested) to return screen configuration data that defines the alternative screen to the multi-functional peripheral 1 for reception and display.

Thereby, when a screen of a function provided from outside is specified as an initial screen, even if the function is changed by an administrator depending on a timing to be used, by presenting an alternative screen giving a notice that the function is changed in advance to the user, it is possible to prevent that a screen that is not desired by the user is displayed and an application activation error occurs.

Description will be given for processing while the alternative screen 45 of FIG. 12 is displayed with reference to FIG. 14. While the alternative screen 45 is displayed (step S21), the display controlling portion 15 judges whether or not to activate the changed application 32 (step S22), and in the case of YES by selecting the “YES” button by the user (activation instruction), similarly to the case of NO at step S7, the display controlling portion 15 requests screen configuration data that defines an initial screen of the updated application 32 (screen corresponding to initial screen information) to the application server 3 and receives it to display on the display portion 11b (step S23). This makes it possible to display a screen like the document management application screen 44 of FIG. 11. Herein, to display the initial screen of the changed application 32 means to activate the changed application 32.

On the other hand, in the case of NO at step S22 by selecting the “NO” button by the user (non-activation instruction) (that is, when no activation instruction is given from the user), the display controlling portion 15 displays a default screen of the multi-functional peripheral 1 (a standard initial screen of the multi-functional peripheral 1) on the display portion 11b (step S24). The display of the default screen can be executed when the display controlling portion 15 acquires data of the default screen from the screen information management DB 16 and provides it to the display portion 11b. The default screen may be a predetermined screen or a screen on which all functions of the multi-functional peripheral itself are selectable in the form of tabs or the like out of any of the screens of the functions of the multi-functional peripheral itself, screens 41 to 43 shown in FIG. 7 to FIG. 9, for example. In the latter case, by selecting any of the functions of the multi-functional peripheral itself from the default screen, the user is able to activate the selected function of the multi-functional peripheral itself.

Alternatively, when it is impossible at step S7 to acquire the application information 52 provided from the application server 3 (corresponding application is deleted), the display controlling portion 15 gives an instruction to display another alternative screen managed by the screen information management DB 16.

The alternative screen displayed on the display portion 11b according to the instruction may describe that an application is deleted and display an OK button for confirmation, for example, like an alternative screen 46 shown in FIG. 13. It may be configured such that a default screen of the multi-functional peripheral 1 is displayed by selecting the OK button by the user.

Note that, when it is impossible at step S4 of FIG. 2 to acquire identification information of a screen relating to the user and initial screen information such as last usage function or when it is impossible at step S5 to determine an initial screen, control may be also performed to display the default screen of the multi-functional peripheral 1. In the case of the first login where the user has never logged in, such processing is also performed and the standard screen of the multi-functional peripheral 1 is displayed.

In addition, after processing at step S9 is completed, the user displays a screen of the desired function while operating the multi-functional peripheral 1 by the operation portion 11 to execute a job and then performs a logout operation. By the logout operation, logout processing is performed in the multi-functional peripheral 1 and the authentication server 2. The logout processing is also executed when the device controlling portion 10 detects that no operation has been made for a predetermined time after the job has ended or after the previous operation or when a login request is made from another user in the same multi-functional peripheral 1.

In the above, although description has been given assuming that in the changed application, the function of the changed part is compatible with the multi-functional peripheral 1, there is also a case where the function is not compatible and can not be used in the multi-functional peripheral 1. Description will be given below taking account of even such a case.

Only when a function of the application 32 that is changed is not compatible with the multi-functional peripheral 1, the display controlling portion 15 may display an alternative screen on the display portion 11b as the initial screen after login. On the other hand, in the case of being compatible, the display controlling portion 15b displays a screen corresponding to initial screen information (that is, for example, a screen at the time of the previous log-off) on the display portion 11b as the initial screen after login. The display method has been described above.

Herein, whether or not to be compatible may be judged by the application server 3. If the function of the application 32 is changed, when the screen judging portion 17 has detected the change (or at the time of detecting the change) as described above in processing at the time of logging in, model information (product model number etc.) of the multi-functional peripheral 1 is transmitted to the application server 3. Thereby, the application server 3 is able to acquire the model information of the multi-functional peripheral 1, and is able to judge compatibility of the application 32 with the multi-functional peripheral 1 from the acquired model information and version information of the application 32. The result of compatibility/incompatibility may be transmitted to the multi-functional peripheral 1.

For example, in the application information 52 of FIG. 10, together with a time and date of update, version information of the application 32 and model information of all multi-functional peripherals 1 capable of using the version are registered for each application ID, and if model information transmitted together from the multi-functional peripheral 1 as device information matches model information of the application information 52, a screen at the time of the previous login is displayed, and if not, the alternative screen 45 like in FIG. 12 is displayed. This makes it possible to give the user to recognize that the multi-functional peripheral 1 that is not compatible with the application 32 is used and to prevent an erroneous operation.

In addition, the judgment of whether or not to be compatible can be also executed on the side of the multi-functional peripheral 1. More specifically, in the side of the multi-functional peripheral 1, an application name that is compatible with itself and data of a version number are stored, and when the screen judging portion 17 detects a change (or after detecting a change), an application name and data of a version number are transmitted from the application server 3 to the multi-functional peripheral 1, so that an up-to-date version number can be acquired in the multi-functional peripheral 1. The multi-functional peripheral 1 compares the application name and the up-to-date version number to the application name that is compatible with itself and data of the version number, thus making it possible to judge whether or not to be compatible on the side of the multi-functional peripheral 1.

Processing after the alternative screen is displayed is as described above, and when “NO” is selected by the user, a default screen is displayed, and when “YES” is selected by the user, an initial screen of the application 32 is displayed.

Moreover, it is preferable for the alternative screen 45 to present such as that “although a part of function is restricted,” do you activate a new application. That is, the display controlling portion 15 preferably presents a notification of the function the usage of which is restricted due to being not compatible on the alternative screen 45. When the function of the application 32 is restricted if the logged-in multi-functional peripheral 1 is used such as the case where the multi-functional peripheral 1 has no function usable in the application 32, it is possible to notify the user of the function to be restricted, thus making it possible to give the user recognize the usable function and to prevent an erroneous operation.

For example, in the application information 52 of FIG. 10, together with the time and date of update, model information of the multi-functional peripheral 1 capable of using all functions of the application 32 is registered for each application ID. For example, when the application 32 is changed to an application corresponding to color reading resolution 1200 dpi, model information of all multi-functional peripherals 1 capable of using color reading resolution 1200 dpi is recorded. When model information transmitted from the multi-functional peripheral 1 matches model information of the application information 52, a screen at the time of the previous login is displayed, and if not, instead of the confirmation screen as shown in FIG. 12, it is displayed that a part of function is restricted such as “1200 dpi can not be used as color reading resolution in this multi-functional peripheral” as the alternative screen 45, to warn the user.

In addition, in various examples described above, as has been referred to another multi-functional peripheral having the same function of the present invention as that of the multi-functional peripheral 1, a plurality of multi-functional peripherals may be connected to the system. In such a configuration, on the assumption that identification information is transmitted as has been described, the authentication server 2 may manage/transmit initial screen information based on the identification information. Thereby, when the user selectively uses a plurality of multi-functional peripherals as usage, it is possible to display an appropriate log-in initial screen for each multi-functional peripheral.

In addition, in various examples described above, it may be configured such that a function of the authentication server 2 is provided inside the multi-functional peripheral 1. When the function of the authentication server 2 shown in FIG. 1 is incorporated as an authentication portion (authentication application) in the multi-functional peripheral 1, it is not necessary to provide the function of the authentication server outside the multi-functional peripheral 1 separately, and therefore, the multi-functional peripheral 1 only needs to be connected to the application server 3 and is able to perform authentication processing by itself, thus being convenient in a small-sized office and the like.

Additionally, the present invention may employ a form as a system provided with a multi-functional peripheral, an authentication server and an application server in the above-described each example. Description will be simply given for main characteristics of this system. This system is a system provided with an authentication server, an application server that stores an application, and a multi-functional peripheral including a display portion capable of performing user authentication processing via the authentication server and processing in cooperation with the application. The multi-functional peripheral is connected to the application server and the authentication server. In addition, in this system, the display controlling portion of the multi-functional peripheral, in the case of detecting that initial screen information transmitted from the authentication server is information indicating a screen relating to a function of the application and the function of the application is changed in the application server, displays an alternative screen giving a notification that the function of the application is changed on the display portion as the initial screen after login. Note that, other applied examples in this system are as described above.

According to the present invention, in a multi-functional peripheral capable of performing user authentication processing in cooperation with the authentication server and processing in cooperation with an application stored in an external application server (processing for realizing the external application function), a user does not need to switch a screen of a function of the multi-functional peripheral itself and a screen of the external application function every time logging in, and is able to access a screen managed by the authentication server immediately after login and it is possible to prevent a phenomenon which is caused by change and deletion of the external application and not assumed by a user even in the case of displaying a screen of the function of the external application.

1. A multi-functional peripheral connected to an authentication server and an application server, capable of performing user authentication processing via the authentication server and capable of performing processing in cooperation with an application program stored in the application server, comprising:
a display portion;
an information reception portion for receiving at a time of logging in from the authentication server initial screen information managed by the authentication server relating it with login information used for the user authentication processing; and
a display controlling portion for displaying on the display portion a screen corresponding to the initial screen information received at the information reception portion as an initial screen after login, wherein
the display controlling portion, in case of detecting that the initial screen information is information indicating a screen relating to a function of the application program and the function of the application program is changed in the application server, displays on the display portion an alternative screen giving a notification that the function of the application program is changed, as the initial screen after login.

2. The multi-functional peripheral as defined in claim 1, wherein
the display controlling portion, when the initial screen information is information indicating a screen relating to the function of the application program, acquires data of a screen corresponding to the initial screen information from the application server to display on the display portion the screen as the initial screen after login.

3. The multi-functional peripheral as defined in claim 1, wherein
the display controlling portion detects a change of the function of the application program by receiving a time and date of change recorded on the application server at a time of a change of the application program and comparing the time and date of change and a time and date of previous logout.

4. The multi-functional peripheral as defined in claim 1, wherein
the display controlling portion, in case of receiving by a user operation an activation instruction of the application program after changing while displaying the alternative screen, displays an initial screen of the application program after changing on the display portion.

5. The multi-functional peripheral as defined in claim 4, wherein
the display controlling portion acquires data of the initial screen of the application program after changing from the application server.

6. The multi-functional peripheral as defined in claim 1, wherein
the display controlling portion, in case of receiving by the user operation a non-activation instruction of the application program after changing while displaying the alternative screen, displays a default screen of the multi-functional peripheral on the display portion.

7. The multi-functional peripheral as defined in claim 1, wherein
the display controlling portion displays the alternative screen on the display potion as the initial screen after login only in case where the function of the application program that is changed is not compatible with the multi-functional peripheral, and displays on the display portion the screen corresponding to the initial screen information as an initial screen after login in case of being compatible.

8. The multi-functional peripheral as defined in claim 7, wherein
the display controlling portion presents a notification on the alternative screen also regarding a function whose use is restricted by being incompatible.

9. A system provided with the multi-functional peripheral as defined in claim 1, the authentication server and the application server.

10. A system provided with the multi-functional peripheral as defined in claim 3, the authentication server and the application server, wherein
the application server, when the application program is changed, records the time and date of the change and transmits the time and date of the change either when it is recorded or when it is required by the multi-functional peripheral.
